(19) United States
(12) Patent Application Publication
(10) Pub. No.: US 2015/0215329 A1
(43) Pub. Date: Jul. 30, 2015

(54) Pattern Consolidation To Identify Malicious Activity

(71) Applicants: Anurag Singla, Cupertino, CA (US); Suranjan Pramanik, Fremont, CA (US); Tomas Sander, New York, NY (US)

(72) Inventors: Anurag Singla, Cupertino, CA (US); Suranjan Pramanik, Fremont, CA (US); Tomas Sander, New York, NY (US)

(21) Appl. No.: 14/418,910

(22) PCT Filed: Jul. 31, 2012
(86) PCT No.: PCT/US2012/049057

§ 371 Date: Jan. 30, 2015

(51) Int. Cl. H04L 29/06; H04L 12/24

(52) U.S. Cl. CPC H04L 63/1416; H04L 63/1425; H04L 63/1441; H04L 41/069

(57) ABSTRACT

A process includes analyzing events reported by computing devices on a network to recognize patterns of events that occurred on the network and sharing with a community, information concerning the patterns detected. The process may also use consolidated information on the patterns to select one or more of the patterns for analysis that identifies whether the selected patterns result from malicious activity. The consolidated information includes information on the patterns detected on the network and information concerning corresponding patterns of events that occurred elsewhere.

### BACKGROUND

Malware is often designed to delay specific malicious effects. For example, many worms, viruses, and trojans attempt a “zero-day attack” to exploit a software vulnerability before software developers are aware of the vulnerability. For maximum effect, a zero-day attack may commence a part of the attack on a specific date, which is after the date on which the worm, virus, or trojan begin to spread. This may particularly be the case when the delayed part of the attack has an easily detectable effect, for example, a particularly harmful effect. The delay in the attack may be intended to allow such malware to spread and accumulate a critical mass of infected devices before the malware is noticed. It is desirable to detect and neutralize such malware as soon as possible and particularly before the more harmful parts of the attack begin. However, antivirus solutions generally use known signatures and heuristics to detect malware, and many of the new attacks are not identified by antivirus solutions until after noticeable damage is done. Antivirus solutions may also require time to update signatures, so that such solutions may only be able to deal with specific malware days or weeks after the zero-day attack of the malware begins. As a result, a great deal of damage can be done.

Pattern discovery processes can perform complex analysis to detect the patterns of events that may otherwise be hidden in the mass of system and user activities. However, an enterprise system management (ESM) installation analyzing events generated throughout a large enterprise can detect so many patterns that security analysis of all the detected patterns may be impractical.

### BRIEF DESCRIPTION OF THE DRAWINGS

FIG. 1 is a block diagram of a system including an enterprise management system connected to share event patterns with other members of a community.

FIG. 2 is a flow diagram of a process for detecting malicious activity through detection and analysis of event patterns.

FIG. 3 is a flow diagram of a process for using the shared canonical forms of detected patterns to identify occurrences of possible malware activity.

FIG. 4 is a block diagram of a manager capable of sharing canonical forms of detected patterns.

FIG. 5 is a flow diagram of a process that uses consolidation of share pattern information to select patterns for analysis.

Use of the same reference symbols in different figures indicates similar or identical items.

### DETAILED DESCRIPTION

Systems and processes for detecting malware may detect patterns of events in individual ESM installations, create canonical forms of detected patterns in each installation, share information concerning the canonical forms with a community, and consolidate shared information from multiple installations to identify which of the patterns that present the greatest threat or likelihood of being malicious activity. The level of threat associated with new event patterns may be scored based on the number or rate of occurrences and how widespread the event patterns are in the community of ESM installations. For example, a threat score for a pattern can be based on the support of the pattern at individual organizations, e.g., the number of machines or user accounts exhibiting the behavior, and/or the number of organizations affected by the pattern. To facilitate such evaluations, the canonical forms of patterns can be consolidated and shared using a public or private exchange, e.g., a threat exchange. Canonical forms of patterns can also be exchanged by security analysts through other modes of communication such as instant messages, emails, forums, or social media. Analysts can study particularly widespread patterns that newly arise to uncover spreading malware before the more devastating part of a zero-day attack begins.

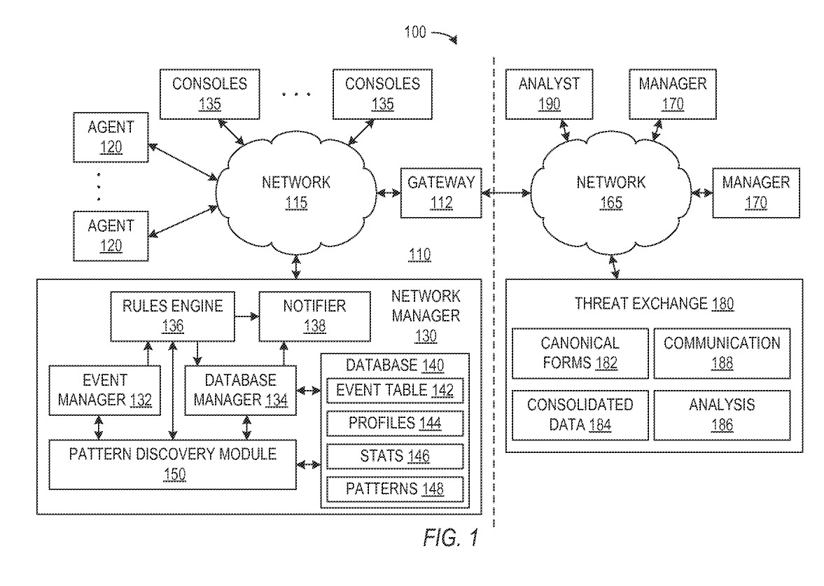

FIG. 1 is a block diagram of a community 100 that includes an enterprise system 110 including network security, e.g., an ESM installation, which can detect patterns of events and share information concerning the detected patterns. The information from system 110 can thus be consolidated with information corresponding to patterns occurring elsewhere and the consolidated information can be used to identify malware activities early in a zero-day.

System 110 includes a network 115, one or more agents 120, and a manager 130. In some implementations, some or all of agents, managers and/or consoles may be combined in a single computing platform or distributed in two or more physical platforms. Network 115 may be a conventional local area network and may be employed to cover all or part of an enterprise. The specific type of network 115 (e.g., the topology of network 115, whether network uses a wireless or wired communication, and which specific protocols are implemented) is generally not critical to the detection of patterns of events and identification of malicious activity as described further herein. In general, network 115 may include devices such as routers and switches for interconnecting computing devices such as servers, network appliances, and personal computers and peripherals such as printers and scanners. Network may further include one or more gateway 112 for connections to other networks 165 including a public or wide area networks such as the Internet. Networks (not shown) that may cover other parts of an enterprise can be served by other network security systems (not shown).

Agents 120 in system 110 may be executed modules that capture, filter, or aggregate local event data from a variety of network security devices and/or applications associated with network 115. Agents 120 may process events in real-time (or near real-time) as events occur or may periodically access logs of events that may be maintained in specific devices. Some typical sources of security events are common network security devices, such as firewalls, intrusion detection systems, and operating system logs. Agents 120 can, for example, collect events from any source that produces event logs or messages and can operate at the native device such as a server, a network appliance, a personal computer, or a gateway 112, at consolidation points within network 115, and/or through simple network management protocol (SNMP) traps.

Manager 130 may be deployed on any computer hardware platform and may, for example, include server-based components that further consolidate, filter, and cross-correlate events received from agents 120. One particular role of manager 130 is to capture and store real-time and historic event data in order to construct a representation of security activity on network 115. For this purpose, manager 130 employs a centralized event database 140, which may include an event table 142 for storage of event data. In some implementations, manager 130 may act as a concentrator for multiple agents 120 and may forward information including event data to another manager (not shown), which may be deployed at a corporate headquarters or elsewhere in an enterprise including network 115.

Consoles 135 may employ applications that allow security professionals to access manager 130 and perform day-to-day administrative and operation tasks such as event monitoring, rules authoring, incident investigation, and reporting. For example, consoles 135 may employ a browser to access security events, knowledgebase articles, reports, and notifications from manager 130 or from other portions of community 100 including managers 170 for other enterprises, a threat exchange 180, analyst resources 190, or other parties. Manager 130 may include a web server component (not shown) accessible via a web browser hosted on a console 135 or a portable computer (not shown) that takes the place of a console 135 and provides some or all of the functionality of a console 135. Browser access may be particularly useful when security professionals are not at the physical location of a device directly connected to network 115. Browser access may also be useful when sharing information on patterns with threat exchange 180 or analyst resources 190. Communication between consoles 135 or remote devices and manager 130 may be bi-directional and encrypted. Access control lists can be used to allow multiple security professionals to use the same manager 130 and database 140. A single manager 130 can thus support multiple consoles 135 or remote devices.

In the embodiment of FIG. 1, manager 130 includes an event manager that communicates with agents 120 to receive event data, and a database manager 134 that implements functions of event database 140. Communications between manager 130 and agents 120 may be bi-directional, e.g., to allow manager 130 to transmit commands to the platforms hosting agents 120. If bi-directional communication with agents 120 is used, event manager 132 may transmit messages to agents 120. If agent-manager communications employ encryption, event manager 132 can decrypt the messages received from agents 120 and encrypt any messages transmitted to agents 120. Event manager 132 may also be responsible for generating some event data messages such as correlation events and audit events, or a rules engine 136 can perform such functions. Event manager 132 can pass event data to database manager 134 either directly or through rules engine 136, and database manager 134 can control storage and organization of event data in database 140. Database manager 134 may also execute search queries or other instructions for retrieving event data from database 140.

Database manager 134, in one implementation, constructs event table in event database 140 using event data received from agents 120 through event manager 132. For example, agents 120 may provide event data in the form of individual events and/or in an aggregated form. An aggregated form of events can be a single representation of multiple events of the same type. For example, instead of providing ten events of varying bytes, e.g., 10, 20, 30, 40, . . . 100 bytes, from a first IP address to a second IP address, agent 120 may send event information representing 550 bytes from the first IP address to the second IP address. In one example, agents 120 provide event manager 132 with an event stream. An event stream is a continuous flow of events, where each event is represented by a set of data fields. Event manager 132 may pass the events to rules engine 136 for processing. Alternatively, events or event data may be aggregated or generated in manager 130, e.g., by event manager or rules engine 136. Database manager 134 may store event data received from agents 120 or generated by manager 130 in event table 142 of database 140. In one implementation, event table 142 may have rows corresponding to individual events and columns corresponding to the fields of the events.

Manager 130 also includes pattern processing capabilities, and rules engine 136 may include rules for invoking pattern detection via database manager 134, such as rules describing when to conduct pattern detection or which users can view pattern detection results. In the illustrated embodiment, manager 130 includes a pattern discovery module 150 that processes event data to recognize patterns in the event data. Pattern discovery module 150 may receive event data from agents 120 via event manager 132, from rules engine 136, or from event database 140 either directly or via database manager 134.

In one implementation, pattern discovery module 150 employs pattern discovery profiles 144, which may be stored in event database 140. Each pattern discovery profile 144 indicates criteria for determining whether a set of events fits a pattern associated with the pattern discovery profile 144. In one specific implementation, a pattern discovery profile 144 can be a resource, e.g., in XML form, that defines the criteria used for discovery of patterns. A pattern discovery profile 144 may, for example, indicate a time duration for occurrence of events to be considered, optional filtering conditions for the events, a set of pattern identification fields containing respective values such as event names, pattern transaction fields such as source and target addresses, a minimum number of distinct activities in the pattern, and a minimum number of repetitions of the patterns across different transactions. Pattern discovery module 150 can process events or event data from database 140 to automatically generate profiles 144. Profiles 144 can alternatively be provided by other sources. For example, pattern discovery module 150 or a user of a console 135 may generate a profile 144, or a profile 144 may be shared through threat exchange or other communications.

Manager 130 can compare events from event table 142 to the criteria defined in pattern discovery profiles 144 to identify matching sets of events corresponding to a pattern 148. For example, manager 130 may use a pattern discovery profile 144 just generated or any previously-stored pattern discovery profile 144 from event database 140. Database manager 134 may then execute SQL commands to compare event fields from event table 142 to criterion defined in the pattern discovery profile 144. A match may include a set of events representing a sequence of activities that satisfy the criteria defined in the pattern discovery profile. Each instance that matches the pattern discovery profile 144 is an occurrence of a pattern 148. The occurrences of a pattern can be used to generate statistics 146 that are respectively associated with the pattern 148 of events on network 115, and the occurrences or statistics 146 can be stored in database 140. Alternatively, every detection of patterns corresponding to specific profiles 144 or pattern 148 can be reported to or shared with community 100.

Systems and methods for generating pattern discovery profiles and detecting patterns from event data are further described in U.S. Pat. No. 7,509,677, entitled “Pattern Discovery in a Network Security System,” which is hereby incorporated by reference in its entirety.

A notifier 138 may generate notifications, e.g., messages, alerts, etc., periodically or when a new patter is detected. Notifier 138 may, for example, send a message containing a canonical form of a pattern 148 and the associated pattern statistics 146 (if any) to threat exchange 180. Also, event data for detected patterns may be displayed, e.g., through a console 135 for user/analyst and/or analyzed in manager 130.

Community 100, as noted above, may including managers 170 installed in other enterprises, a threat exchange 180, and analyst resources 190 that may be connected to each other and to system 110 through a public network 165. Each manager 170 may be identical to network manager 130 but serve to monitor network activity on a different network (not shown) that is part of a different organization or enterprise. Accordingly, managers 170 can similarly share information concerning detected patterns of events occurring on their respective networks.

Threat exchange 180 may be a service implemented on a server or other hardware platform that may be able to communicate with ESM installations, e.g., with managers 130 and 170, and with analyst resources 190. One function of threat exchange 180 is to consolidate information on patterns that may be detected at multiple enterprises. In particular, threat exchange 180 may construct a table 182 containing the canonical forms of patterns that were reported to threat exchange 180. A table 184 may contain consolidated statistics or other data including entries that are associated with the canonical forms, including, for example, a total number of organizations or enterprises reporting detection of the pattern, the total number of machines or user accounts affected by the pattern of events, and a score indicating a risk or threat level of the pattern of events. The score calculated or otherwise determined from consolidated data 184 can be use to prioritize and select patterns for analysis. Threat exchange 180 may also consolidate or collect shared analysis on any of the patterns detected. Analysis 186 may indicate whether detected patterns have been analyzed and determined to be malicious or benevolent activity. Analysis 186 may also indicate solutions or actions to be taken in response to detecting patterns. A communication module 188 may include a web server component that allows managers 130 and 170 to upload canonical forms, associated statistics, or analysis to threat exchange 180 or download canonical forms 182, consolidated data 184, and analysis 186, e.g., for pattern detection, analysis, and corrective action. Communications module may similarly allow analysts 190 to upload or download information.

Analyst resources 190 may be a service provided separately or in association with threat exchange 180 to identify malicious activity or recommend corrective actions.

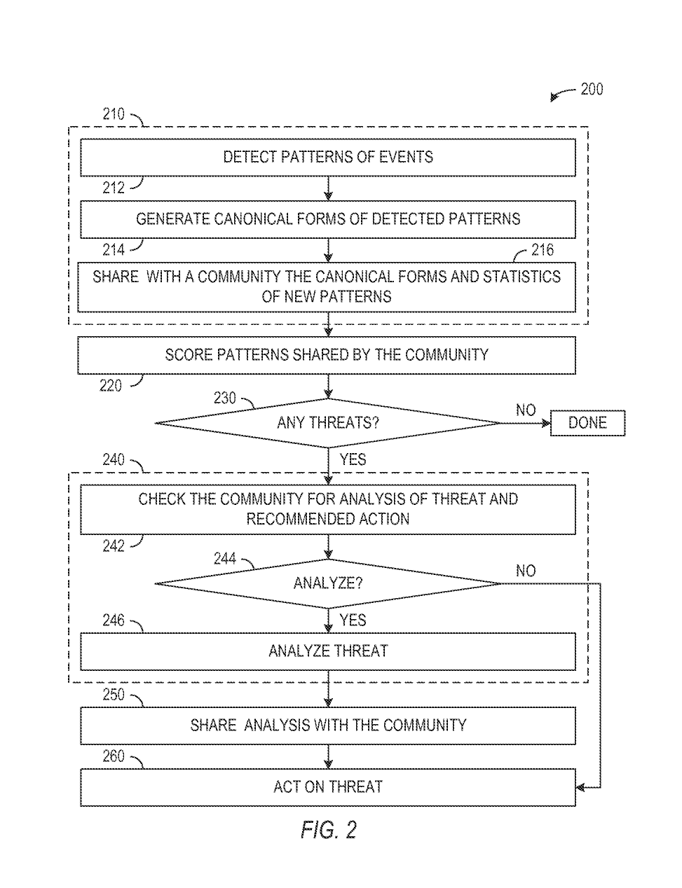

FIG. 2 illustrates a process 200 that uses pattern detections for identification of malicious activity early during a zero-day attack and possibly before delayed and particularly harmful parts of the attach occurs. For illustration, process 200 is described herein with reference to activities in the system of FIG. 1, although process 200 may be conducted in different systems.

Process 200 begins with a block 210 that detects and shares patterns of events occurring in a monitored network. Block 210 may particularly be conducted in an ESM installation such as shown in FIG. 1, in which, manager can implement a pattern detection block 212. Block 212 detects patterns of events occurring in the monitored network during a specific time period. A block generates canonical forms of some or all of the patterns detected, and a block 216 shares the canonical forms of some or all of the patterns for which block 214 generated canonical forms. In general, a canonical form only needs to be generated for a pattern that will be shared. Some implementations of process 200 may only generate canonical forms (or share patterns) if the pattern has not been classified by the detecting system, e.g., manager 130, or the community 100 as corresponding to benevolent or malicious activity. Detected patterns may be classified, for example, by analysis such as described further below or by history. For example, patterns that have been occurring for extended periods of time without harm may be believed to be less likely to be malicious than is a newly appearing pattern. In one implementation, an ESM installation may only share a pattern if the pattern is new to the installation, i.e., if the first occurrence of the pattern occurred less than some specific time ago.

Block 214 can generate the canonical form of a pattern from raw event data to remove or otherwise protect potentially confidential information in the raw event data and to provide a format for an event pattern that can be adapted to many network systems. Raw events often contain information in the form of log lines. In system 110, agents 120 can parse an event or log line to identify the fields, e.g., an event name, a source address, a target address etc. and send some or all of event fields to manager 130. Manager 130 may enrich or augment the event data using an asset model, user model and other information. An identified event pattern 148 in system 110 may include a detailed snapshot of the various field values used in computing of the pattern. This information is often confidential and therefore not to be shared with other parties. Block 214 when generating a canonical form can extract or alter fields containing confidential information, so that the altered event data for the pattern can be shared with community 100 or specifically with threat exchange 180. Some field values can thus be converted to agreed-upon generic values that convey required information for identifying patterns without conveying confidential information. For example, the canonical form of a pattern of events may be a representation of the pattern that avoids disclosing specific device or system details and that can be generically mapped to devices commonly found on a network. In one implementation, a canonical form 148 of a pattern may be the sequence of activities represented by the pattern identification fields (e.g., Event Names) in the pattern discovery profile 144. One specific implementation of a canonical form of a pattern may further include a set of events where each event may include an activity identification field. Different values for the activity field may indicate activities such as a TCP probe, port scanning, shellcode x86 NOOP, and successful login to name a few. Along with the canonical form of the pattern, the support for the pattern can also be shared. The support is the number of unique source-target combinations where the pattern is observed. In one implementation, the source and target identification fields may indicate the address and network zone of the source or target. Source and target fields could also refer to a single field indicating a type of value, e.g., User ID or Credit Card number, without indicating the specific or confidential value.

Block 216 shares with a community detected patterns in the canonical form with or without auxiliary information such as statistical information associated with the detected pattern. As described above, community 100 may include administrators of other ESM installations such as managers 170, threat exchange 180, and other security professionals or analyst resources 190. Community 100 may particularly include users of a particular type or brand of manager 130 and analyst resources 190 that a manufacturer of manager 130 provides as a service to the community 100, including the enterprise using manager 130. Sharing 216 may include posting the new pattern to threat exchange 180, which the manufacturer of manager 130 may maintain.

Threat exchange 180 can consolidate reports of patterns from many installations and accumulate information regarding each pattern such as the number of installations which have reported the patter and the number of occurrences of the pattern at all of the installations. As part of the consolidation, a block 220 can check for matching patterns reported in community 100 and may generate a score indicating the likelihood that the pattern represents malicious activity. Threat exchange 180 can be configured to implement block by collecting, cataloging, and scoring patterns that managers 130 and 170 share. Alternatively, a manager 130 can check the records of threat exchange for prior reports from other managers 170 that match the current report of a new pattern, and manager 130 can generate a score that suggests the level of threat that the pattern represents to network 115. In determining a threat score, a pattern may present more of a threat and have a higher threat score if the pattern is new, occurs at a number of different installations that employ threat exchange 180, and has a large number of occurrences. A new pattern that is widespread and has a high rate of occurrence at a number of installations will generally merit additional investigation.

A score indicating the level of threat of a pattern may be determined using a sum of the reports of occurrences weighted according to the reputation of the reporting party. Equation 1, for example, illustrates an example in which the score is a sum over all parties or participants of the product of the reputation of the party and the pattern support at the party's installation. In Equation 1, PartyReputation is the reputation of the reporting participant, and PatternSupport is a reported statistic or value, e.g., number of devices or user accounts involved in the pattern, the participant reported for the pattern. An alternative threat score may be a normalized score, where for each participant, the score contains as a contribution that is a percentage or normalized pattern support in the participant's IT system. For example, a contribution to the score from each participant may be equal to a ratio, e.g., pattern support divided by a measure for the size of IT system. This will make contributions of smaller systems more important in the overall threat score, and the score more equally influenced by each of the participants affected. The measure for the size of an organization can be determined in several ways. For example, one measure may be the numbers of servers in the participant's system.

$$Score = {\sum }_{All Reporting Parties} ( PartyReputation * PatternSupport ) \qquad Equation 1$$

Decision block 230 can determine whether any of the patterns should be further analyzed, e.g., have a threat score above a specific level. Although not all widespread new patterns will actually correspond to malware, such criterion can prioritize patterns and reduce unnecessary analysis or false positives. For example, entirely spurious random patterns will tend to have a low aggregated count among different parties or installations and therefore low threat scores and low priority for analysis. Organization specific patterns will tend to have a low aggregated count among different organizations and therefore low threat scores and low priority for analysis. In either case, decision 230 can avoid analysis of patterns that are unlikely to be malicious activity. This prioritization of patterns for analysis can reduce the total amount of analysis of patterns from an impractical level to a manageable level. Sharing of analysis in community can further reduce the burden of pattern analysis on individual installations.

Any pattern that block 230 selects or identifies for analysis can be examined in block 240 to determine whether the new pattern corresponds to the activities of malware. For example, threat exchange 180 upon identifying a pattern with a high threat score can notify analyst resources 190 or administrators of managers 130 and 170 that the detected pattern has a high risk of being malicious activity, and the one or more of the warned parties can analyze occurrences of the pattern. In the implementation of analysis 240 shown in FIG. 2, a first step 242 checks the community to determine whether any other analyst in the community has already analyzed the pattern. If someone in the community has already analyzed the pattern, a course of action to address the malicious activity may also be available. Occasional new “benevolent” patterns that receive a high or rising count can be recognized as benevolent by the community through shared efforts and shared information and thus participants can reduce their own workload for weeding out false positives as well as for identifying threats and choosing a course of action.

Analysis block 240 of FIG. 2 also includes a decision 244 regarding whether a patter needs further analysis. In particular, if decision block 230 identified a pattern as a potential threat, another party may have already analyzed the pattern and provided a conclusion regarding to whether the pattern is the activity of malware and may even have provided a recommended action (or inaction if the pattern is benevolent). To secure the community against insiders intentionally declaring a malicious pattern to be benevolent, threat exchange 180 can apply a mechanism using some voting among randomly assigned community members who need to agree that a suspicious pattern is benevolent. Randomly assigning analysis to community members reduces the chance that a coalition of malicious participants could misinform the community. If an administrator of an installation trusts the analysis and the recommendation from the community, the administrator may jump to a block 260 and act on the threat. If the prior analysis is nonexistent or insufficient or if the administrator does not trust the prior analysis, the administrator in block 246 can investigate occurrences of the pattern on their system to attempt to identify whether the pattern represents benevolent or malicious activity.

The analysis of a pattern may involve analyzing all the events contributing to the pattern and also gaining situational awareness by analyzing the activities happening on the source/target close to the timing of events contributing to the pattern. The amount of effort for such analysis may vary depending upon the data to be analyzed for understanding the impact of the activity sequence determined by the pattern discovery. A block 250 can share the results of analysis 246 with the community, for example, by posting the results through threat exchange 180 or other system or by directly communicating the results to potentially interested parties through email, instant messaging, or other communications.

Block 260 represents acting on patterns that have been analyzed. In general, if a pattern represents benevolent or benign activity, no action may be required. However, if pattern analysis 240 reveals the activity to be the activity of malware, the software or hardware can be quarantined to prevent perpetuation of the pattern of activity and to stop harmful delayed actions that would have been the results of a zero-day attack. Accordingly, the activity of malware may be detected and stopped before the zero-day attack harms the system.

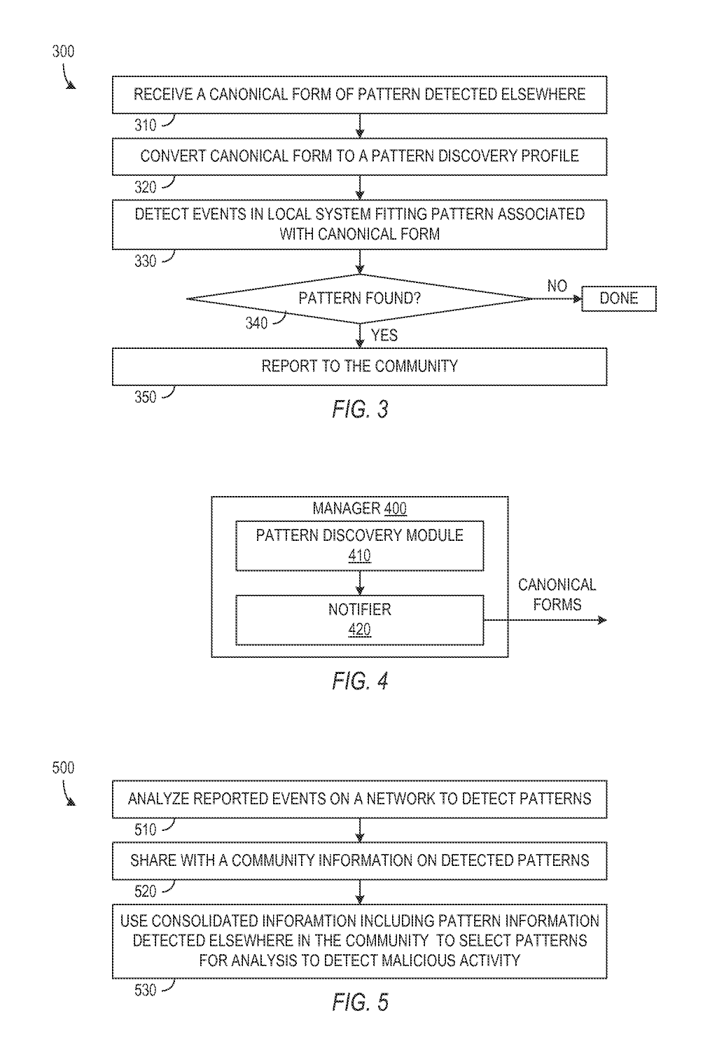

Process 200 illustrates a specific implementation in which an installation identifies and shares pattern information without external guidance. In another implementation, an installation can use shared canonical forms of patterns and investigate whether that event pattern has occurred in their system. FIG. 3, for example, illustrates an implementation of a process 300 for using the canonical forms of patterns from other systems to recognize patterns in a home system. Process 300 begins with receiving 310 a canonical form of a pattern detected elsewhere. In system 110 of FIG. 1, a canonical form of a pattern may be received, for example, by manager 130 checking threat exchange 180 for any new patterns and accessing the canonical form of a new pattern. Alternatively, an administrator with access to manager 130 may become aware of a new pattern from threat exchange 180 or communication from another administrator or analyst.

The canonical form of a patter can be converted into a pattern discovery profile in block 320 if necessary. Conversion may not be necessary, for example, if the canonical form is the same as a format for a pattern discovery profile. Block 330 can then search for events matching the canonical form. For example, in system 110, pattern discovery module 150 can search event database 140 for events that match the pattern having the canonical form. If the pattern is not then found, a decision block 340 may determine that no further action is currently necessary, but block 330 may be periodically executed. If the pattern is found, process 300 branches to block 350 to report the finding to the community. The system may then perform blocks 220 through 260 of FIG. 2 to evaluate whether the pattern represents malicious activity and to take appropriate actions.

FIG. 4 illustrates a simple implementation of a manager 400 that can share pattern information from an ESM installation. Manager 400 includes a pattern discovery module 410 that is configured to detect patterns of events in a network. A notifier 420 is configured to share canonical forms of detected patterns with a community.

Manager 400 of FIG. 4 can be employed in a process to select patterns for analysis that prioritizes or selects patterns for analysis. FIG. 5, for example, is a flow diagram of a process 500 for selecting patterns. Process 500 particularly includes a block 510 that analyzes reported events on a network to detect event patterns and a block 520 that shares information on the detected patterns with a community. The community may include other ESM installations and managers as described above. Manager 530 can then in a block 530, use consolidated information including pattern information detected elsewhere in the community to select patterns for analysis.

Some systems and processes described herein can be implemented using a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although the system and processes has been described with reference to particular implementations, the description is only an example of some implementations and should not be taken as a limitation. Various adaptations and combinations of features of the embodiments disclosed are within the scope of the invention as defined by the following claims.

What is claimed is:

1. A process comprising:
analyzing events reported by a plurality of computing devices on a network to recognize patterns of events that occurred on the network;
sharing information concerning the patterns detected, wherein the information is shared with a community; and
using consolidated information on the patterns to select one or more of the patterns for analysis that identifies whether the selected patterns result from malicious activity, wherein
the consolidated information includes information on the patterns detected on the network and information concerning corresponding patterns of events detected elsewhere.

2. The process of claim 1, wherein sharing the information comprises:
generating a canonical form of each of the patterns of events recognized; and
including the canonical forms in the information shared with the community.

3. The process of claim 2, wherein generating the canonical form comprises:
collecting event data for a set of events that corresponds to the pattern;
isolating activity representations in the event data from representations of actors performing activities; and
sharing the activity representation without the representations of the actors performing the activities to thereby avoid sharing confidential information from the event data.

4. The process of claim 1, wherein using the consolidated information comprises prioritizing the patterns in an order that indicates to analyst respective levels of threat of the patterns.

5. The process of claim 1, wherein sharing comprises providing the information concerning the patterns to a threat exchange that is accessible in the community.

6. The process of claim 1, wherein using the consolidated information comprises determining a number of networks on which one of the patterns of events has occurred.

7. The process of claim 1, wherein using the consolidated information comprises determining a number of machines affected by occurrences of one of the patterns of events.

8. The process of claim 1, further comprising analyzing one of the selected patterns to detect malware that caused the pattern, wherein the malware is detected before the malware executes a delayed part of a zero-day attacked.

9. The process of claim 1, wherein using the consolidated information for a pattern includes determining a score for the pattern, wherein the score is a sum of a plurality of contributions that depend on respective reports of the pattern by a plurality of organizations.

10. The process of claim 9, wherein each of the contributions is weighted according to a reputation of the organization associated with the contribution.

11. A non-transitory computer readable media containing instructions that when executed by a computing system causes a process comprising:
analyzing events reported by a plurality of computing devices on a network to recognize patterns of events that occurred on the network;
sharing information concerning the patterns detected, wherein the information is shared with a community; and
using consolidated information on the patterns to select one or more of the patterns for analysis that identifies whether the selected patterns result from malicious activity, wherein
the consolidated information includes information on the patterns detected on the network and information concerning corresponding patterns of events detected elsewhere.

12. A system comprising:
a pattern discovery module configured to detect patterns of events in a network; and
a notifier configured to share canonical forms of detected patterns with a community, wherein the canonical forms when consolidated with information on patterns detected elsewhere indicate respective levels of threat of the patterns resulting from malicious activity.

13. The system of claim 12, further comprising a threat exchange that is in communication with the community and is configured to provide the community with information that is associated with the canonical forms and that result from consolidating information from a plurality of the pattern discovery modules.

14. The system of claim 13, wherein the threat exchange is operable to determine a score for the patter, wherein the score is a sum of a plurality of contributions that depend on respective reports of the pattern by a plurality of organizations.

15. The system of claim 12, wherein the canonical form includes activity representations that are extracted from the event data without including representations of actors performing activities in the canonical form.
